(19) United States
(12) Patent Application Publication
(10) Pub. No.: US 2020/0345466 A1
(43) Pub. Date: Nov. 5, 2020

(54) MONOCHROME COMPOSITE MILLING BLOCKS AND METHOD FOR THE PRODUCTION THEREOF

(71) Applicant: KULZER GMBH, Hanau (DE)

(72) Inventors: Klaus RUPPERT, Maintal (DE); Alfred HOHMANN, Schmitten (DE); Stephan DEKERT, Wehrheim/Obernhain (DE); Andrea HAMBACH, Usingen (DE)

(73) Assignee: KULZER GMBH, Hanau (DE)

(21) Appl. No.: 16/642,575

(22) PCT Filed: Oct. 1, 2018
(86) PCT No.: PCT/EP2018/076592

§ 371 Date: Feb. 27, 2020

(30) Foreign Application Priority Data
Oct. 4, 2017 (DE) 10 2017 122 993.0

(51) Int. Cl. A61C 13/08; A61C 13/00; A61C 13/14; B29C 39/38; B29C 39/42; B29C 39/26

(52) U.S. Cl. CPC A61C 13/081; A61C 13/0022; A61C 13/14; B29K 2033/12; B29C 39/42; B29C 39/26; B29C 39/38

(57) ABSTRACT

The invention relates to a method for the production of blocks of material of a polymerized dental composite material as well as to the blocks of material obtainable according to the method, in which (i) a polymerisable dental composite material is transferred into a pressure-resistant casting mould (100), (ii) a pressure in the range of 10 to 500 MPa is applied to the polymerisable dental composite material in the pressure-resistant casting mould, and (iii) at least a part of the casting mould and/or the polymerisable material is heated in a defined manner to a temperature of 90 to 150° C.

The invention relates to a method for the production of blocks of material of a polymerized dental composite material as well as to the blocks of material obtainable according to the method, in which (i) a polymerizable dental composite material is transferred into a pressure-resistant casting mould, (ii) a pressure in the range of 10 to 500 MPa is applied to the polymerizable dental composite material in the pressure-resistant casting mould, and (iii) at least a part of the casting mould or the polymerisable material is heated in a defined manner to a temperature of 90 to 150° C.

When producing composite milling blocks from highly filled composites, cracking often occurs due to the dimensioning and polymerization shrinkage of the milling blocks. In addition, undesired formation of bubbles during production and injection of the highly filled composite pastes is another technical challenge when producing milling blocks. These flaws increase the reject rate of the milling blocks. Invisible bubbles formed in the material, which only become noticeable during material processing, is particularly detrimental.

It was therefore an object of the invention to provide a method for the production of composite milling blocks being suitable for material-removing processes, preferably a milling or composite material-removing processing by means of laser energy. Moreover, milling blocks of a defined dimension shall be economically producible by the method. The method shall reliably avoid, preferably prevent, the formation of defects, blowholes, cracks, bubbles, changes of the external geometry and/or stresses inside the milling block. The milling blocks produced according to the method are suitable for the production of single crowns and small-scale bridges.

The objects are solved by the method according to the invention according to claim 1, as well as by use of the casting mould according to the invention and by the blocks of material obtainable according to the method according to the invention, which are suitable as milling blocks for milling processing or material-removing processing by means of laser energy.

According to the invention, the object is solved by a highly filled and highly viscous composite being filling, preferably into a metal mould, having one or more mould cavities, in the desired sizes, for the production of the blocks of material and being polymerized under defined heating and defined high pressure.

A subject matter of the invention is a method for the production of at least one block of material of a polymerized dental composite material, in particular of at least one three-dimensional block of material, in which

(i) a polymerisable dental composite material is transferred into a pressure-resistant casting mould,

(ii) a pressure in the range of 10 to 500 MPa, preferably 125 to 250 MPa, is applied to the polymerisable dental composite material in the pressure-resistant casting mould, in particular in the respective mould cavity of the casting mould,

(iii) at least a part of the casting mould as well as the polymerisable material are heated in a defined manner to a temperature of 90 to 150° C., wherein in particular the dental composite material is thermally polymerized, and preferably at least one block of material is obtained.

After step (iii), the casting mould may cool a) under pressure or b) under normal pressure (1 bar). Preferably, cooling to 20 to 23° C. is used. In the next step, the at least one block of material may be removed from the casting mould, in particular from the mould cavity. Preferably, one block of material may be obtained per each mould cavity, which is suitable for the production of prosthetic restorations in a material-removing process.

The polymerisable dental composite material in the pressure-resistant casting mould is preferably hot isostatically pressed and polymerized in the method according to the invention (in the following referred to as HIPP). According to a further particularly preferred embodiment, the polymerisable dental composite material in the pressure-resistant casting mould is hot isostatically pressed and, in particular by one sided heat supply, polymerized in a thermally-directed manner (HIPP). In the present case, thermally-directed is understood to mean a spatially directed polymerization front in the polymerisable composite material. Said polymerization front may be generated by one-sided tempering of the polymerisable composite material, in particular of the polymerisable composite material being in a geometrical mould cavity of the casting mould.

The pressure which is applied to the casting mould in the method may amount from 10 to 500 MPa, preferably from 50 to 250 MPa, preferably 100 to 250 MPa, particularly preferably 100 to 200 MPa. According to the invention, the pressure may preferably amount to 125 to 250 MPa. The pressure on the casting mould is maintained during the method and, if necessary, readjusted to maintain the pressure set. The composite, in particular a pasty composite, is pressed into the casting mould under defined pressure and optionally at a defined temperature in the method. The casting mould is subsequently closed with at least one top cover, such that the pressure-resistant casting mould with top cover may also be referred to as press mould.

Preferably, the three-dimensional blocks of material have a geometrical shape, in particular the blocks of material have a defined geometrical three-dimensional figure. A three-dimensional block of material preferably has at least an edge length of at least 10 mm respectively, preferably of 14 mm. Blocks of material used as milling blocks preferably have the form of cuboids, wherein the cuboids preferably have an area of 12 mm×14 mm as well as a height of 17 or 18 mm, alternatively an area of 14×14 mm, or 15×15 mm as well as a height of 17 to 18 mm. One to all edges and vertices may be straight or rounded.

Likewise a subject matter of the invention is a dental block of material which does not have any blowholes, cracks and/or cavities having an extent in one dimension of greater than or equal to 0.05 mm, preferably their dimension is less than or equal to 100 μm, particularly preferably less than or equal to 50 μm, more preferably less than or equal to 20 μm.

Another subject matter of the invention is a block of material, in particular a cuboid, having at least one first edge length or a diameter of greater than or equal to 14 mm and at least one second edge length of greater than or equal to 14 mm and optionally a further edge length of greater than or equal to 14 mm.

In step (i) of the method, the composite material is transferred into the casting mold without preheating at ambient room temperature (20° C.) or preferably being preheated, in particular it is preheated to 25 to 50° C. The composite material preferably is preheated to 35 to 45° C.

In addition, it may be preferred for the casting mold to be tempered or preheated to 25 to 45° C., into which the preheated composite material is then transferred. The casting mould may preferably be preheated to 30 to 40° C.

According to a preferred embodiment of the invention, in the method in step (i), in (i.1) the polymerisable dental composite material being preheated to a temperature in the range of 25 to 50° C., preferably to 30 to 45° C., in particular in the range of 35 to 40° C. plus/minus 5° C., preferably in the range of 35° C. plus/minus 3° C., is transferred into at least one mould cavity of the pressure resistant casting mould, in particular under pressure, preferably in at least two mould cavities of the casting mould, and (i.2) at least one mould cavity filled with preheated composite material is obtained or at least two mould cavities filled with preheated composite material are obtained. The casting mould may preferably have two to one hundred mound cavities, preferably two to ten mould cavities, or, for example, four to ten mould cavities.

The composite material is furthermore, preferably under pressure, filled into the mould cavities and is preferably subsequently kept under pressure by the press punch. The pressure under which the composite material is transferred into the mould cavities is preferably in the range of 2 to 10 bar, in particular 2.5 to 5 bar.

A highly filled and highly viscous composite comprises an inorganic filler content of 60 to 85 by weight, based on the total composition of 100% by weight.

Subsequently, (i.3) a top cover of the pressure-resistant casting mould is put onto the at least one mould cavity filled with preheated composite material, wherein preferably at least one press punch is arranged at the top cover, and the press punch as being a male part gears into a mould cavity as being a female part of the casting mould.

Alternatively, a top cover of the pressure-resistant casting mould may, preferably in (i.1), be put onto the at least one mould cavity filled with composite material, wherein preferably at least one press punch is arranged at the top cover, and the press punch as being a male part gears into the mould cavity as being a female part of the casting mould.

In a further alternative, a top cover of the pressure-resistant casting mould may be put onto at least two mould cavities filled with preheated composite material, wherein preferably at least two press punches are arranged at the top cover, and each press punch as being a male part gears into one mould cavity as being a female part of the casting mould. The press punches and mould cavities may gear into each other, preferably in such a way that little horizontal and/or vertical movement of the press punches is possible in the cavity of the mould cavities. Press punches and mould cavities are designed in such a way that the press punch may compress the composite material being in the mould cavity, in particular the press punch may reproducible build-up a defined pressure on the composite material. In particular, the compatible press punches and mould cavities are designed in such a way that the respective press punch may compress the composite material being in the respective mould cavity, in particular the press punch may reproducibly build-up a defined pressure on the composite material. Preferably, the below-mentioned pressure is transferred on the composite material via the press punch.

A circumferenting sealing face is formed around the mould cavity, a sealing face is also formed as a negative circumferenting around the press punch. At least one spillway is provided in the middle part outside the circumferenting sealing face of the mould cavity to receive overspilling or squeezed out composite material.

In method step (ii), a pressure in the range of 125 to 250 MPa is applied to the polymerisable dental composite material in the pressure-resistant casting mould.

In particular, in method step (ii), a weight of 10 to 25 tonnes is applied to the casting mould, preferably of 12 to 25 tonnes, particularly preferably of 15 to 20 tonnes.

According to the invention, it is more preferred for the polymerisable dental composite material in the pressure-resistant casting mould material to be hot isostatically pressed and polymerized, wherein the polymerization front is substantially perpendicular to the vector of force (N=kg·m·s⁻²). In this context, it is particularly preferred for the polymerization front to run to meet the vector of force perpendicular to the vector of force. The direction of movement of the polymerization front is thereby parallel to the pressure applied. In the method, it is preferred for the bottom part of the casting mould to be heated so that the polymerization front runs to meet the force applied and, preferably, the pressure may be readjusted during the method.

Subsequently, in method step (iii), at least a part of the casting mould and/or the polymerisable material is heated in a defined manner to a temperature of 110 to 150° C. Preferably, the bottom part of the casting mould and/or the top cover of the casting mould is heated to a temperature in the range of 110° C. to 150° C., preferably to 110 to 130° C. Preferably, only the bottom part or the top cover is heated one way to ensure directed polymerization. Preferably, in the method, (iii) at least a part of the casting mould and/or the polymerisable material is heated in a defined manner to a temperature of 110 to 150° C. for 0.1 to 60 minutes.

In this context, it is more preferred for the polymerisable material to be heated to 110 to 150° C. within 30 minutes, preferably heated to 110 to 140° C. within 20 minutes, more preferably heated to 130° C. within 15 minutes.

Alternatively, it is preferred for the bottom part of the casting mould and/or the top cover of the casting mould to be heated to a temperature in the range of 110 to 150° C. within 5 to 30 minutes, preferably heated to 110 to 140° C. within 20 minutes, more preferably heated to 130° C. within 15 minutes. The polymerisable dental material is heated a polymerized via heat conduction.

In doing so, at least a part of the casting mould, in particular the bottom part is heated to a temperature of 90 to 150° C. within 20 minutes, preferably heated to a temperature of 90 to 150° C. within 15 minutes, particularly preferably to 110 to 140° C. within 15 minutes. Preferably to 120 to 140° C. plus/minus 5° C. within approximately 10 minutes plus/minus 3 minutes. Preferably, the bottom part is heated and the polymerisable composite material is heated via heat conduction of the casting mould. Alternatively, the top cover may be heated accordingly or the top cover and the bottom part may be heated together. However, hot isostatical pressing is preferably performed in such a way that pressure is carried out from the side opposing the heated component in the casting mould, i.e. pressure is applied from one side to the casting mould, and the casting mould is heated from the opposing side.

In the method according to the invention, a block of material, in particular a geometrical block of material of a polymerized composite material is preferably obtained, preferably in step (iv), having a defect volume of 15·10⁻⁶% by volume to 14·10⁻⁴% by volume, based on the total block of material.

In the method according to the invention, a composite material may be used as polymerisable dental composite material, comprising (i) 70 to 85% by weight of an inorganic filler component comprising at least one dental glass, as well as optionally at least one amorphous metal oxide, such as in particular amorphous silicon dioxide and/or zirconium dioxide, (ii) 10 to 30% by weight of a mixture of at least two different urethane (meth)acrylates, (iii) 0.01 to 5% by weight of at least one di-, tri-, tetra- or multi-functional monomer not being an urethane (meth)acrylate, (iv) 0.01 to 10% by weight of at least one initiator, of an initiator system, as well as optionally of at least one stabilizer, and optionally of at least one pigment, wherein the total composition of the composite material amounts to 100% by weight.

A subject matter of the invention is a polymerisable dental composite material comprising (i) 70 to 85% by weight of an inorganic filler component comprising at least one dental glass, as well as optionally at least one amorphous metal oxide, (ii) 10 to 30% by weight of a mixture of at least two different urethane (meth)acrylates, (iii) 0.01 to 5% by weight of at least one di-, tri-, tetra- or multi-functional monomer not being an urethane (meth)acrylate, and (iv) 0.01 to 10 by weight of at least one initiator, an initiator system, as well as optionally stabilizers, and optionally pigments, wherein the total composition of the composite material amounts to 100 by weight, as well as a polymerized composite material having a flexural strength of greater than or equal to 230 MPa and an elastic modulus of 15 to 20 GPa.

According to a particularly preferred embodiment, the dental composite material comprises (ii) 10 to 30% by weight of a mixture of at least two different urethane (meth)acrylates comprising at least one difunctional urethane (meth)acrylate having a bivalent alicyclic group and a difunctional urethane (meth)acrylate having a bivalent alkylene group, such as UDMA, as well as optionally at least one at least tetrafunctional dendritic urethane (meth)acrylate.

Particularly preferred difunctional urethane (meth)acrylates having a bivalent alicyclic group comprise a bifunctional 2′-aza-alkylene tetrahydrodicyclopentadiene with 5 to 20 C-atoms as well as optionally with 2 to 5 O-atoms and optionally further 1 to 3 N-atoms in the alkylene residue. Bis-(4′,7′-dioxa-3′,8′-dioxo-2′-aza-decyl-9′-en)tetrahydrodicyclopentadiene, Bis-(4′,7′-dioxa-3′,8′-dioxo-2′-aza-9′-methyl-decyl-9′-en)tetrahydrodicyclopentadiene and/or mixtures thereof as well as mixtures of the isomers are particularly preferred. The isomers may comprise the 3,8-/ 3,9-/4,8-/3,10-/4,10 isomers, possibly being present as cis isomer or trans isomer. The generalized structure of Bis-(4′,7′-dioxa-3′,8′-dioxo-2′-aza-decyl-9′-en)tetrahydrodicyclo-pentadiene is exemplarily shown below:

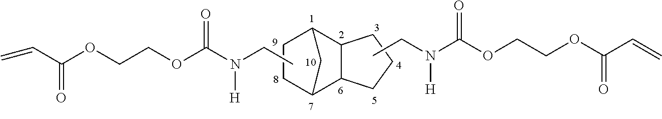

Preferably, the content of components (iii) amounts to 0.15 to 5% by weight, particularly preferably 1.0 to 2% by weight of a dimethacrylic ester of a polyether, such as preferably a dimethacrylate polyethylene glycol, dimethacrylate polypropylene glycol. Dimethacrylate triethylene glycol (TEGDMA) and diethylene glycol dimethacrylate (DEGMA) are particularly preferred.

Another subject matter of the invention is a block of material of a polymerized dental composite material, in particular a geometrical block of material, obtainable according to the method according to the invention, which preferably has a flexural strength of greater than or equal to 230 MPa and an elastic modulus of 15 to 20 GPa. IS06872 is chosen for determination due to the dimension of the testing rods. The block of material is suitable to be used in a process for material-removing processing by means of milling and/or in a material-removing process by means of laser energy.

The block of material according to the invention of a polymerized composite material preferably has a defect volume of 15·10⁻⁶% by volume to 14·10⁻⁴% by volume, preferably of 20·10⁻⁶% by volume to 10·10⁻⁵% by volume.

Preferably, the block of material is a cylinder having the following dimensions: height of greater than or equal to 10 mm to less than or equal to 15 mm and a radius of greater than or equal to 3 mm to less than or equal to 7 mm, alternatively with a height of greater than or equal to 10 mm to less than or equal to 20 mm and a radius of greater than or equal to 5 mm to less than or equal to 7 mm, the dimensions of a cuboid of the block of material preferably amounts to a, b and c greater than or equal to 4 mm, in particular greater than or equal to 10 mm and a less than or equal to 20 mm, in particular a less than or equal to 18 mm, b less than or equal to 14 mm and c less than or equal to 20 mm, in particular c less than or equal to 18 mm.

The block of material according to the invention is a monochromic block of material made of a composite material, in particular a homogenous monochromic block of material.

Moreover, the block of material made of polymerized composite material may be used for the production of dental prosthetic restorations comprising crowns, inlays, onlays, superstructures, artificial teeth, prosthetic teeth, dental bridges, dental bars, spacers, veneer of a milling blank, of dental prostheses, of a part of a surgical prosthesis, of an implant and of orthodontic appliances. The polymerized composite material may additionally be used as composite material for the production of direct adhesive dental restorations, orthodontic appliances and instruments.

Another subject matter of the invention is a method, in which a pressure-resistant casting mould is used which is formed in multiple parts and comprises a) at least one bottom part having at least one integral center part having at least one mould cavity, preferably having at least two mould cavities to 20 mould cavities, advantageously having 2 to 6 mould cavities, as well as at least one top cover. Alternatively, the casting mould in multiple parts may have b) at least one bottom part, in particular a planar bottom part, at least one center part having at least one mould cavity, preferably having at least two mould cavities, as well as at least one top cover. The bottom part and the center part may be formed integrally or in multiple parts. Integrally is understood to mean that the bottom part and the center part having at least one mould cavity, preferably at least two optionally to 50 mould cavities, is produced from an integral component in one part.

The pressure-resistant casting mould, the bottom part, the center part having at least one mould cavity, preferably having at least two mould cavities, and/or the top cover, each independently, may be made of a metal, a metallic alloy, or a temperature-resistant plastic, such as a high-performance polymer, or a temperature-resistant hybrid material. Preferably, all components of the casting mould are made of the same material. Preferably, they are made of steel, preferred steals are chromium- and/or molybdenum-containing steals, such as, for example, 1.2343 (C 0.37/Si 1.0/Cr 5.3/Mo 1.3/V 0.4), preferably hardened, 1.2312 (C 0.4/Mn 1.4/Cr 1.9/Mo 0.2/S 0.05) or 1.4571 (Cr 17/Mo 2/No 11.5/Ti 0.7), stainless steel, preferably the surface of the stainless steel is not electropolished (the particulars are in % by weight). The surface of the mould cavities in the casting mould is preferably provided with a defined surface roughness. Ceramic, silicon carbide as well as pressure-resistant hybrid materials are considered to be further materials.

Likewise a subject matter of the invention is a pressure-resistant casting mould, in particular for use in the method according to the invention, wherein the pressure-resistant casting mould is formed of multiple parts and comprises at least one bottom part, in particular a planar bottom part, at least one center part having at least one mould cavity, preferably having at least two mould cavities, as well as at least one top cover. All components of the pressure-resistant casting mould are preferably made of stainless steel.

The at least one mould cavity in the casting mould preferably has a geometrical shape, in particular the mould cavity has a defined geometrical three-dimensional figure. Preferably, the geometric from is formed without undercut(s). In addition, the geometrical shape of a mould cavity has a draft, in particular having an opening angle of 0.5° to 2°, preferably of 1° to 2°. Preferably, the at least one mould cavity is substantially rectangular conically tapered.

The inner surface of the at least one mould cavity preferably has a defined surface roughness, in particular with an average roughness value of Rₐ N3 to N9, preferably at N4 to N8, preferably at N4 to N7, particularly preferably at N6. Rₐ preferably is less than 1.0 μm.

Advantageously, the mould cavity 2 has a little draft of approx. 1 to 2° to facilitate demoulding of the geometrical block of material 3 after the polymerization process. Furthermore, it has proved to be advantageous for demoulding if the inner surface 11 of the mould cavity 2 is not extremely smooth but has a defined—low—surface roughness (approx. less than or equal to Rₐ 7 or Ra 6). However, a roughness that is too high interferes/prevents demoulding.

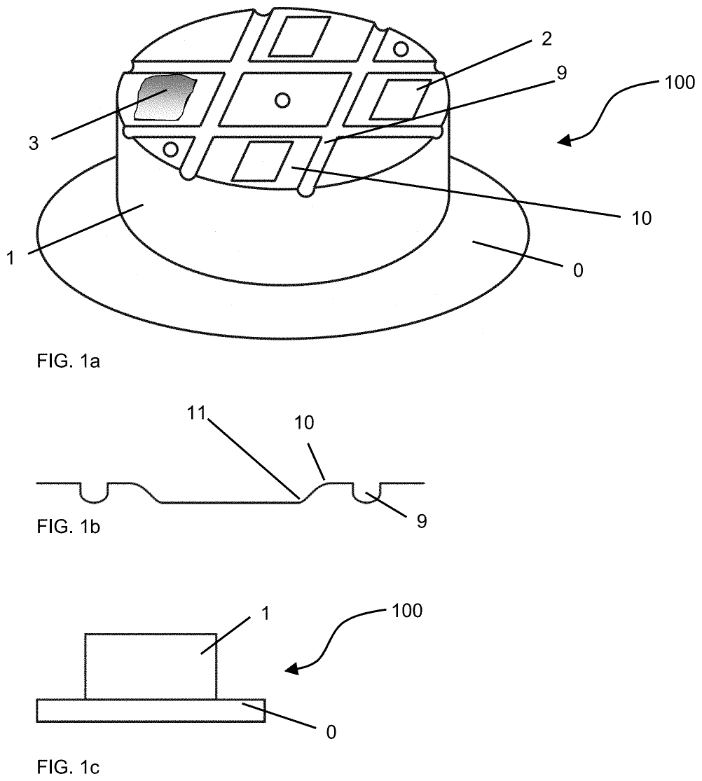

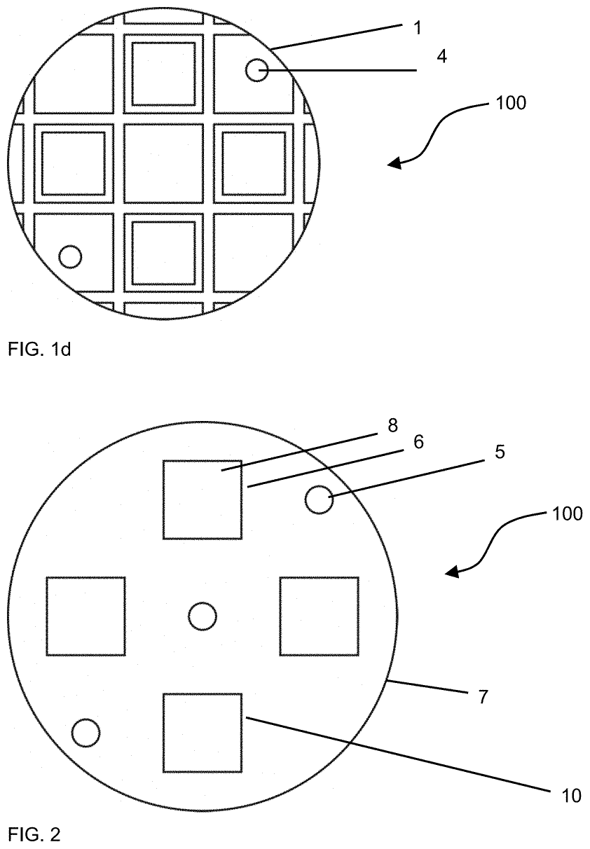

In the following, FIGS. 1a to 1c, 2, 3 and 4 are illustrated without limiting the invention to the specific embodiment.

The pressure-resistant casting mould 100 may comprise three single components or may consist of three components, a planar bottom part 0 (see FIG. 1), a center part 1 with appropriate casting moulds (see FIGS. 1a, 1b and 1c) as well as a top cover 7 with integrated press punches 8 (see FIG. 2). The components are to be arranged relative to each other in just one position via appropriate construction elements, such as e.g. guide bolts 4 and appropriate blind holes 5. FIG. 1b shows a generalized cross section of the mould cavities by showing the inner surface 11 as well as also the sealing face 10 at the mould cavity 2 and the spillway 9.

Process sequence: At first, the center part 1 is put onto the bottom plate 0 and connected to each other via the guide bolts 4 in the provided blind holes 5. Subsequently, the mould cavities 2 are filled, preferably bubble-free, with a defined amount of preheated non-polymerized composite material having a temperature of approx. 35° C. After having filled the available mould cavities 2, the top cover 7 is put onto in such a way that the press punches 8 are exactly oriented above the mould cavities 2. Since the dimensions of press punch 8 and casting mould 2 are exactly coordinated, exact position of the press punches and casting moulds relative to each other is important for the production of high-quality blocks of material suitable for dental use. Due to this exact coordination, the remaining gap between casting mould and press punch is kept as small as possible with a defined clearance, preferably smaller than or equal to 5 1/100 mm, preferably smaller than or equal to 3 1/100 mm.

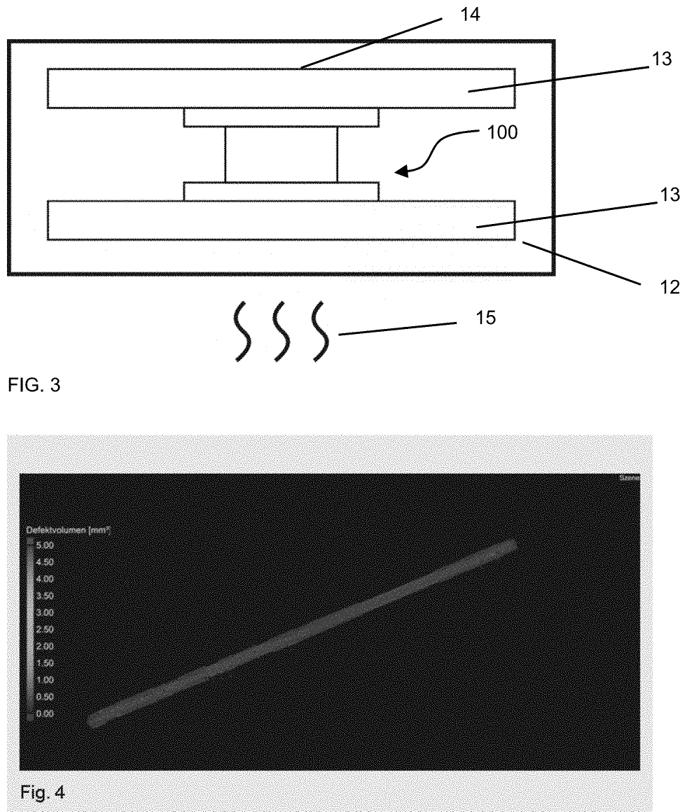

The pressure-resistant casting mould 100 is now transferred into a hot press 12 (see FIG. 3) and the pressure on the pressure-resistant casting mould 100 is raised to approx. 15-20 tonnes within approx. 5-10 sec. The slightly conical press punches 8 which improve the accuracy of fit and allow for better sealing of the casting mould, squeeze excess material out of the casting mould into a spillway 9 and then seal the casting mould with increasing press force by means of the appropriate sealing faces (6 sealing face at the press punch, 10 sealing face at the casting mould). Due to the chosen geometry of the casting moulds 2, the press punches 8 and the sealing faces 6/10, the press punch 8 may exert pressure to the composite material, by means of which polymerization shrinkage can be compensated and preferably minimized to avoided. At the same time, bubbles possibly being in the composite material may be isostatically grouted. After rendering the press pressure, the temperature is increased to start the polymerization. The press pressure is maintained and readjusted during the whole hot polymerization process. In the method according to the invention, at first, the press pressure is thus adjusted and optionally later the temperature is heated in a defined manner to 90 to 150° C., wherein preferably the press pressure is readjusted over the whole period of heating. Preferably, the press pressure is also maintained during cooling.

The whole mould 100 is advantageously made of an afore-mentioned steel to receive the high press forces, wherein the center part 1 is additionally hardened so that the mould cavity does not deform geometrically.

After closing the press plates 13 of the hot press 12 according to FIG. 3, the mould 100 is slowly heated by means of heat conduction to 120° C. within approx. 10 min to start the polymerization reaction. The pressure-resistant casting mould 100 is thereby kept under a pressure 14 of 125 to 250 MPa by an applied force at the top cover 7. In this context, it is preferred for just one press plate 13, here the bottom plate 0, to be heated, in order to control the polymerization in a directed manner from the bottom to the top cover 7. By this measure, the opposing press punch in the top cover 7 may be pressed until the end and the polymerization shrinkage can be compensated. Likewise, it is possible to heat the top cover plate 7 and to apply pressure 14 to the bottom plate 0 further.

After finishing the polymerization process, in order to avoid stresses, the mould is cooled in a directed manner to approx. 40° C. within 10 min, the mould is disassembled and the polymerized blocks are removed. Cooling is preferably carried out symmetrically from both sides via the top cover and the bottom part to avoid stresses.

The material blocks can be checked for invisible bubbles by means of X-ray CT. Cavities can be detected as defect volumes in defined incremental layers of a defined thickness in the illustration shown in FIG. 4. According to the invention, blocks of material of a polymerized composite material are obtainable, having a defect volume of less than or equal to 1·10⁻⁶%, by volume to 14·10⁻⁴%, by volume. The samples are analyzed using non-destructive X-ray CT method.

### LIST OF REFERENCE NUMERALS

0 bottom part, in particular bottom plate
1 center part
2 mould cavities
3 block of material
4 guide bolt
5 blind holes
6 sealing face at the press punch
7 top cover, in particular top cover plate
8 press punch
9 spillway
10 sealing face at the mould cavity
11 inner surface
12 hot press
13 press plates
14 pressure
15 temperature control
100 pressure-resistant casting mould

1. A method for the production of at least one block of material (3) of a polymerized dental composite material, in which
(i) a polymerisable dental composite material is transferred into a pressure-resistant casting mould (100),
(ii) a pressure in the range of 10 to 500 MPa is applied to the polymerisable dental composite material in the pressure-resistant casting mould,
(iii) at least a part of the casting mould as well as the polymerisable material are heated in a defined manner to a temperature of 90 to 150° C.
wherein the polymerisable dental composite material in the pressure-resistant casting mould is hot isostatically pressed and polymerized, wherein the polymerization front is substantially perpendicular to the vector of force (N).

2. The method according to claim 1, wherein the pressure-resistant casting mould (100) is formed in multiple parts and comprises at least a) a bottom part (0) having at least one integral center part (1) having at least one mould cavity (2), as well as at least one top cover (7) or b) a bottom part (0), at least one center part (1) having at least one mould cavity (2), as well as at least one top cover (7).

3. The method according to claim 1, wherein the pressure-resistant casting mould, the bottom part, the center part having at least one mould cavity and/or the top cover, each independently, are made of a metal, a metallic alloy, or a temperature-resistant plastic, or a temperature-resistant hybrid material.

4. The method according to claim 1, in which in (i.1) the polymerisable dental composite material being preheated to a temperature in the range of 25 to 50° C. is transferred into at least one mould cavity of the pressure resistant casting mould, and (i.2) at least one mould cavity filled with preheated composite material is obtained.

5. The method according to claim 1, in which
a) in (i.3) a top cover of the pressure-resistant casting mould is put onto the at least one mould cavity filled with preheated composite material, wherein at least one press punch (8) is arranged at the top cover, and the press punch as being a male part gears into a mould cavity (2) as being a female part of the casting mould (100), or
b) in (i.1) a top cover of the pressure-resistant casting mould is put onto the at least one mould cavity filled with composite material, wherein preferably at least one press punch is arranged at the top cover, and the press punch as being a male part gears into the mould cavity as being a female part of the casting mould.

6. The method according to claim 1, wherein (ii) a pressure in the range of 125 to 250 MPa is applied to the polymerisable dental composite material in the pressure-resistant casting mould.

7. The method according to claim 1, wherein (iii) at least a part of the casting mould or the polymerisable material is heated in a defined manner for 0.1 to 60 seconds to a temperature of 110 to 150° C.

8. The method according to claim 1, wherein the polymerisable dental composite material in the pressure-resistant casting mould is hot isostatically pressed and polymerized (HIPP).

9. (canceled)

10. The method according to claim 1, wherein the polymerisable dental composite material in the pressure-resistant casting mould is hot isostatically pressed and polymerized in a thermally-directed manner (HIPP).

11. The method according to claim 1, wherein the polymerisable dental composite material, comprises
(i) 70 to 85% by weight of an inorganic filler component comprising at least one dental glass, as well as optionally at least one amorphous metal oxide,
(ii) 10 to 30% by weight of a mixture of at least two different urethane (meth)acrylates,
(iii) 0.01 to 5% by weight of at least one di-, tri-, tetra- or multi-functional monomer not being an urethane (meth)acrylate,
(iv) 0.01 to 10% by weight of at least one initiator, of an initiator system, as well as optionally of at least one stabilizer, and optionally of at least one pigment, wherein the total composition of the composite material amounts to 100% by weight.

12. The method according to claim 1, wherein a block of material of a polymerized composite material is obtained, having a defect volume of 15·10⁻⁶% by volume to 14·10⁻⁴% by volume, based on the total block of material.

13. A pressure-resistant casting mould (100) for use in a method according to claim 1, wherein the pressure-resistant casting mould (100) is formed of multiple parts and comprises at least one bottom part (0), at least one center part (1) having at least one mould cavity (2), as well as at least one top cover (7).

14. The pressure-resistant casting mould according to claim 13, wherein the at least one mould cavity has a geometrical shape.

15. The pressure-resistant casting mould according to claim 13, wherein the at least one mould cavity (2) has an inner surface having a defined surface roughness with an average roughness value of Rₐ N3 to N9.

16. A block of material (3) obtainable according to a method according to claim 1, wherein the block of material of a polymerized composite material has a defect volume of 15·10⁻⁶% by volume to 14·10⁻⁴% by volume, based on the total block of material.

17. The method according to claim 1, wherein the pressure-resistant casting mould (100) is formed in multiple parts and comprises at least a) a bottom part (0) having at least one integral center part (1) having at least two mould cavities (2), as well as at least one top cover (7) or b) a bottom part (0), at least one center part (1) having at least two mould cavities (2), as well as at least one top cover (7).
